(19) United States
(12) Patent Application Publication
(10) Pub. No.: US 2014/0152878 A1
(43) Pub. Date: Jun. 5, 2014

(54) SOLID-STATE IMAGING DEVICE

(71) Applicant: PANASONIC CORPORATION, Osaka (JP)

(72) Inventors: Suguru OZAWA, Toyama (JP); Motonari KATSUNO, Toyama (JP); Masayuki TAKASE, Osaka (JP)

(73) Assignee: PANASONIC CORPORATION, Osaka (JP)

(21) Appl. No.: 14/172,659

(22) Filed: Feb. 4, 2014

Related U.S. Application Data
(63) Continuation of application No. PCT/JP2012/004307, filed on Jul. 3, 2012.

(30) Foreign Application Priority Data
Aug. 10, 2011 (JP) 2011-175051

(51) Int. Cl. H04N 9/64

(52) U.S. Cl. CPC H04N 9/646
USPC 348/273

(57) ABSTRACT

A solid-state imaging device includes a plurality of color filters, which are composed of a plurality of first color filters and a plurality of second color filters. In plan view: the first color filters and the second color filters are arranged alternatively in each of an X direction and a Y direction, and thus form a checkerboard pattern; and each of the first color filters, at a corner portion thereof, (i) has an oblique side that extends diagonally with respect to the X and Y directions, and (ii) is adjacent to another one of the first color filters that is located diagonally therefrom. Each one of the first color filters is partitioned from another one of the first color filters located diagonally therefrom and adjacent thereto at a corner portion by a shift portion of the barrier wall that extends in parallel with the oblique side.

### CROSS REFERENCE TO RELATED APPLICATION

This is a continuation application of PCT Application No. PCT/JP2012/004307 filed Jul. 3, 2012, designating the United States of America, the disclosure of which, including the specification, drawings and claims, is incorporated herein by reference in its entirety.

### TECHNICAL FIELD

The present disclosure relates to a solid-state imaging device, and in particular, to a structure of color filters disposed above photoelectric conversion units in a solid-state imaging device.

### DESCRIPTION OF THE RELATED ART

Recently, there has been an increased demand for solid-state imaging devices with higher imaging quality. In order to realize solid-state imaging devices with higher imaging quality, improvement remains to be made in imaging sensitivity, characteristics related to the problem of color mixture, etc., which are particularly important factors when realizing solid-state imaging devices with higher imaging quality.

Color mixture is a phenomenon occurring in a solid-state imaging device, where light entering obliquely from above a first pixel, among adjacent first and second pixels each having a color filter transmitting a different color, enters (leaks into) the second pixel without passing through the color filter of the second pixel. A solid-state imaging device in which the above-described problem of color mixture occurs has low imaging quality.

As an example of a technology for suppressing color mixture, Patent Literature 1 and Patent Literature 2 propose providing a barrier wall between adjacent color filters. In the following, explanation is provided of such a technology, with reference to FIG. 1B.

As illustrated in FIG. 1B, according to the technology proposed in Patent Literatures 1 and 2 (hereinafter referred to as “the conventional technology”), color filters 99a and 99b having rectangular shapes in plan view are arranged alternately in each of the X axis direction and the Y axis direction in FIG. 1B, and thus form a checkerboard pattern. Due to this, at a corner portion X₉₂ of each one of the color filters 99a and 99b, a side extending in the X axis direction and a side extending in the Y axis direction meet at an angle of 90 degrees.

Further, in the solid-state imaging device according to the conventional technology, a barrier wall 98 made of silicon oxide is disposed between adjacent ones of the color filters 99a and 99b. Thus, the barrier wall 98 has a grid structure. In other words, each one of the color filters 99a and 99b is formed in one of a plurality of apertures defined by the barrier wall 98 having the grid structure. The solid-state imaging device according to the conventional technology, due to having such a structure, suppresses color mixture to a certain extent.

### CITATION LIST

### Patent Literature

[Patent Literature 1]
Japanese Patent Application Publication No. 1103-282403
[Patent Literature 2]
Japanese Patent Application Publication No. 2009-111225

### SUMMARY

### Technical Problem

However, according to the conventional technology proposed in Patent Literatures 1 and 2, the barrier wall 98 has a relatively great width at an intersection portion where a portion of the barrier wall 98 extending in the X axis direction and a portion of the barrier wall 98 extending in the Y axis direction intersect (indicated by the arrow B in FIG. 1B). Such an intersection portion with relatively great width allows entry of light therefrom, and thus is problematic. Specifically, light entering from such intersection portions directly enter light-receiving units of pixels without passing through color filters, and thus causes color mixture.

Accordingly, the conventional technology disclosed in Patent Literatures 1 and 2 is not sufficient for preventing color mixture.

In view of the above, one aim of the present invention is to provide a solid-state imaging device that prevents color mixture while having high imaging performance.

### Solution to the Problems

One aspect of the present invention is a solid-state imaging device characterized as follows.

The solid-state imaging device pertaining to one aspect of the present invention includes: a semiconductor substrate; a plurality of photoelectric conversion units disposed in the semiconductor substrate so as to form a matrix along a main surface of the semiconductor substrate; a wiring layer disposed above the semiconductor substrate; a plurality of color filters disposed above the wiring layer, the color filters each corresponding to a different one of the photoelectric conversion units, and thus forming a matrix; and a barrier wall disposed above the wiring layer and between adjacent ones of the color filters.

In the solid-state imaging device pertaining to one aspect of the present invention, the color filters are composed of a plurality of first color filters and a plurality of second color filters, and in plan view from a direction perpendicular to the main surface of the semiconductor substrate, in the matrix formed by the color filters, the first color filters and the second color filters are arranged alternately in each of a row direction and a column direction, and thus form a checkerboard pattern, the first color filters are greater than the second color filters in terms of area, and each one of the first color filters, at a corner portion thereof, (i) has an oblique side that extends diagonally with respect to the row direction and the column direction, and (ii) is adjacent to another one of the first color filters that is located diagonally therefrom, the each one of the first color filters being partitioned from the another one of the first color filters by a shift portion of the barrier wall that extends in parallel with the oblique side.

### Advantageous Effects

In the solid-state imaging device pertaining to one aspect of the present invention, at the corner portion of each one of the first color filters, the barrier wall disposed between adjacent ones of the color filters has the shift portion, which extends diagonally. Due to this, in the solid-state imaging device pertaining to one aspect of the present invention, the area of intersection portions of the barrier wall (i.e., intersections in a grid structure) is smaller than in the solid-state imaging device pertaining to the conventional technology. Accordingly, in the solid-state imaging device pertaining to one aspect of the present invention, the amount of light entering light-receiving units, etc., by passing through the intersection portions of the barrier wall is smaller than in the solid-state imaging device pertaining to the conventional technology.

Accordingly, the solid-state imaging device pertaining to one aspect to the present invention prevents color mixture while having high imaging performance.

### BRIEF DESCRIPTION OF THE DRAWINGS

FIG. 1A is a schematic plan view illustrating a structure of color filters 9a, 9b and a barrier wall 8 in a solid-state imaging device pertaining to an embodiment, and FIG. 1B is a schematic plan view illustrating a structure of color filters 99a, 99b and a barrier wall 98 in a solid-state imaging device pertaining to conventional technology.

FIG. 2 is a schematic cross-sectional view illustrating a structure of part of the solid-state imaging device pertaining to the embodiment.

FIG. 3A is a schematic plan view illustrating a structure of an intersection portion of the barrier wall 8 in the solid-state imaging device pertaining to the embodiment, and FIG. 3B is a schematic plan view illustrating an intersection portion of the barrier wall 98 in the solid-state imaging device pertaining to the conventional technology.

FIGS. 4A and 4B are schematic cross-sectional views each illustrating part of a manufacturing process of the solid-state imaging device pertaining to the embodiment.

FIGS. 5A and 5B are schematic cross-sectional views each illustrating part of the manufacturing process of the solid-state imaging device pertaining to the embodiment.

FIGS. 6A and 6B are schematic cross-sectional views each illustrating part of the manufacturing process of the solid-state imaging device pertaining to the embodiment.

FIGS. 7A and 7B are schematic cross-sectional views each illustrating part of the manufacturing process of the solid-state imaging device pertaining to the embodiment.

FIGS. 8A and 8B are schematic cross-sectional views each illustrating part of the manufacturing process of the solid-state imaging device pertaining to the embodiment.

FIG. 9A is a schematic plan view illustrating the structure of the intersection portion of the barrier wall 8 in the solid-state imaging device pertaining to the embodiment, and FIG. 9B is a schematic plan view illustrating the structure of the intersection portion of the barrier wall 98 in the solid-state imaging device pertaining to the conventional technology.

### DESCRIPTION OF EMBODIMENTS

### Overview of Aspects of Present Invention

One aspect of the present invention is a solid-state imaging device including: a semiconductor substrate; a plurality of photoelectric conversion units disposed in the semiconductor substrate so as to form a matrix along a main surface of the semiconductor substrate; a wiring layer disposed above the semiconductor substrate; a plurality of color filters disposed above the wiring layer, the color filters each corresponding to a different one of the photoelectric conversion units, and thus forming a matrix; and a barrier wall disposed above the wiring layer and between adjacent ones of the color filters.

In the solid-state imaging device pertaining to one aspect of the present invention, the color filters are composed of a plurality of first color filters and a plurality of second color filters, and in plan view from a direction perpendicular to the main surface of the semiconductor substrate, in the matrix formed by the color filters, the first color filters and the second color filters are arranged alternately in each of a row direction and a column direction, and thus form a checkerboard pattern, the first color filters are greater than the second color filters in terms of area, and each one of the first color filters, at a corner portion thereof, (i) has an oblique side that extends diagonally with respect to the row direction and the column direction, and (ii) is adjacent to another one of the first color filters that is located diagonally therefrom, the each one of the first color filters being partitioned from the another one of the first color filters by a shift portion of the barrier wall that extends in parallel with the oblique side.

In the solid-state imaging device pertaining to one aspect of the present invention, at the corner portion of each one of the first color filters, the barrier wall disposed between adjacent ones of the color filters has the shift portion, which extends diagonally. Due to this, in the solid-state imaging device pertaining to one aspect of the present invention, the area of the intersection portions of the barrier wall (i.e., intersections in a grid structure) is smaller than in the solid-state imaging device pertaining to the conventional technology. Accordingly, in the solid-state imaging device pertaining to one aspect of the present invention, the amount of light entering light-receiving units, etc., by passing through the intersection portions of the barrier wall is smaller than in the solid-state imaging device pertaining to the conventional technology.

Accordingly, the solid-state imaging device pertaining to one aspect to the present invention prevents color mixture while having high imaging performance.

Further, the following variations of the solid-state imaging device pertaining to one aspect of the present invention may also be yielded by modification.

In the solid-state imaging device pertaining to one aspect of the present invention, in plan view from the direction perpendicular to the main surface of the semiconductor substrate, at the corner portion of the each one of the first color filters, each of a side that extends in the row direction and a side that extends in the column direction may meet the oblique side at an angle greater than 90 degrees. Such a modification reduces the area of the intersection portions of the barrier wall to a further extent, and thus is advantageous for suppressing color mixture.

In the solid-state imaging device pertaining to one aspect of the present invention, the first color filters may be color filters that mainly transmit light within a green wavelength range, and the second color filters may be composed of color filters that mainly transmit light within a red wavelength range and color filters that mainly transmit light within a blue wavelength range. According to such a modification, color filters corresponding to the color green are used as the first color filters, which are greater than the second color filters in terms of area in plan view. As such, such a modification further improves the sensitivity of the solid-state imaging device pertaining to one aspect of the present invention.

The solid-state imaging device pertaining to one aspect of the present invention may further include: a plurality of microlenses disposed above the color filters, the microlenses each corresponding to a different one of the color filters. The microlenses may be composed of a plurality of first microlenses each corresponding to a different one of the first color filters and a plurality of second microlenses each corresponding to a different one of the second color filters, and in plan view from the direction perpendicular to the main surface of the semiconductor substrate, the first microlenses may be greater than the second microlenses in terms of size. According to such a modification, the microlenses are formed to have sizes in accordance with the sizes of the corresponding color filters. As such, such a modification further improves the sensitivity of the solid-state imaging device pertaining to one aspect of the present invention.

In the solid-state imaging device pertaining to one aspect of the present invention, in plan view from the direction perpendicular to the main surface of the semiconductor substrate, the barrier wall, in the row direction, may have a continuous crank shape such that a position of the barrier wall in the column direction alternates between a first position and a second position with the shift portion connecting a first portion and a second portion of the barrier wall respectively corresponding to the first position and the second position, the first portion and the second portion each extending in the row direction and each disposed between two color filters, among the color filters, that are adjacent in the column direction, the two color filters between which the first portion is disposed and the two color filters between which the second portion is disposed being adjacent to each other in the row direction. Such a modification provides the first color filters and the second color filters with the maximum possible sizes. As such, such a modification further improves the sensitivity of the solid-state imaging device pertaining to one aspect of the present invention.

In the solid-state imaging device pertaining to one aspect of the present invention, in plan view from the direction perpendicular to the main surface of the semiconductor substrate, the barrier wall, in the column direction, may have a continuous crank shape such that a position of the barrier wall in the row direction alternates between a first position and a second position with the shift portion connecting a first portion and a second portion of the barrier wall respectively corresponding to the first position and the second position, the first portion and the second portion each extending in the column direction and each disposed between two color filters, among the color filters, that are adjacent in the row direction, the two color filters between which the first portion is disposed and the two color filters between which the second portion is disposed being adjacent to each other in the column direction. Similar as the previously-described modification, such a modification provides the first color filters and the second color filters with the maximum possible sizes. As such, such a modification further improves the sensitivity of the solid-state imaging device pertaining to one aspect of the present invention.

In the solid-state imaging device pertaining to one aspect of the present invention, in plan view from the direction perpendicular to the main surface of the semiconductor substrate, the first color filters may have an octagonal shape, and the second color filters may have a rectangular shape.

### Embodiment

In the following, description is provided on one form of implementation, with reference to the accompanying drawings. It is to be noted that in the embodiment, description is provided based on one exemplary form of implementation, which is used for the mere sake of explaining, in as easy a way as possible, the structure and the effects of the technology disclosed in the present disclosure. As such, the present disclosure is not limited to the description provided in the embodiment, except with regards to features that are considered as being fundamental.

1. Barrier Wall Structure in Solid-State Imaging Device

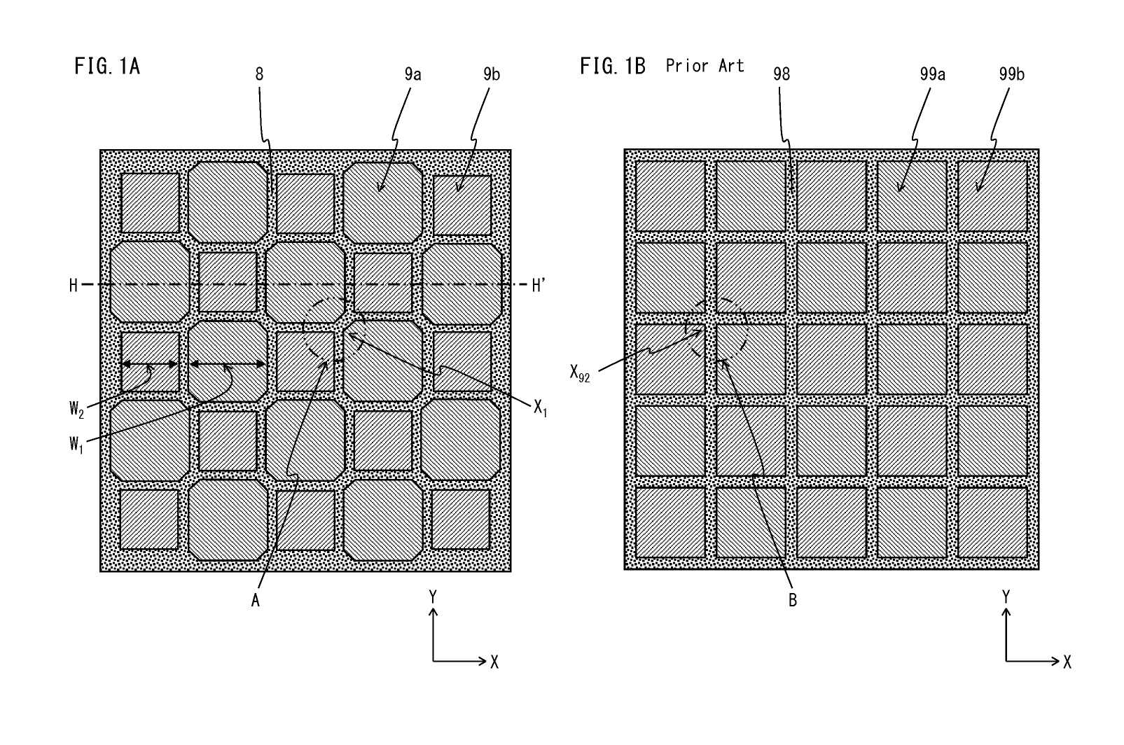

In the following, description is provided on a barrier wall structure in a solid-state imaging device pertaining to an embodiment, with reference to FIG. 1A. FIG. 1A is an upper surface diagram illustrating the barrier wall structure in the solid-state imaging device pertaining to the embodiment.

As illustrated in FIG. 1A, in the barrier wall structure pertaining to the embodiment, a plurality of first color filters 9a and a plurality of second color filters 9b are arranged alternately in each of a row direction and a column direction, and thus form a checkerboard pattern. The first color filters 9a and the second color filters 9b differ from one another in terms of the color transmitted thereby, or that is, the wavelength range transmitted thereby. Specifically, the first color filters 9a are, for example, color filters mainly transmitting light within the wavelength range of green light. The second color filters 9b are, for example, composed of color filters mainly transmitting light within the wavelength range of red light and color filters mainly transmitting light within the wavelength range of blue light.

As illustrated in FIG. 1A, at a corner portion X₁ of each of the first color filters 9a, each of a side of the first color filter 9a that extends in the X axis direction in FIG. 1A and a side of the first color filter 9a that extends in the Y axis direction in FIG. 1A meets an oblique side of the first color filter 9a at an angle greater than 90 degrees.

As illustrated in FIG. 1A, the first color filters 9a are greater than the second color filters 9b in terms of area, in plan view from a direction perpendicular to the drawing. Further, a barrier wall 8 is disposed so as to be present between (i) each pair of a first color filter 9a and a second color filter 9b that are adjacent in the row direction, (ii) each pair of a first color filter 9a and a second color filter 9b that are adjacent in the column direction, and (iii) each pair of one first color filter 9a and another first color filter 9a that are adjacent in a diagonal direction. Here, the barrier wall 8, between a pair of one first color filter 9a and another first color filter 9a that are adjacent in a diagonal direction, has a portion that extends diagonally with respect to the X axis direction and the Y axis direction (refer to the portion indicated by the arrow A in FIG. 1A, for example). In the following, such a portion of the barrier wall 8 extending diagonally is referred to as a shift portion.

Note that in the present embodiment, in plan view, the first color filters 9a have an octagonal shape having an oblique side at corner portions thereof, whereas the second color filters 9b each have a rectangular shape. However, note that the first color filters 9a and the second color filters 9b may each have various shapes other than the respective shapes described above in plan view. For example, in plan view, the first color filters 9a may each have a decagonal shape or a polygonal shape with more than ten sides. This similarly applies to the second color filters 9b.

2. Part of Structure of Solid-State Imaging Device

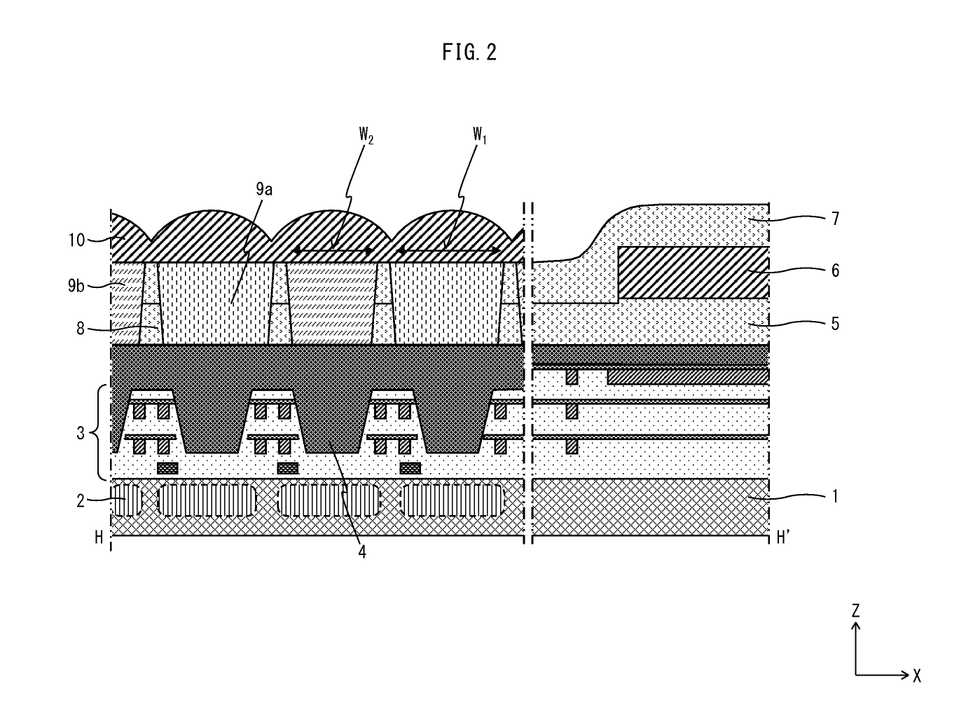

In the following, description is provided on a main part of the structure of the solid-state imaging device pertaining to the embodiment, with reference to FIG. 2. Note that FIG. 2 is a schematic cross-sectional view taken along the direction H-H′ in FIG. 1A.

As illustrated in FIG. 2, the solid-state imaging device pertaining to the embodiment includes a semiconductor substrate 1. The semiconductor substrate 1 has light-receiving units 2 formed therein. Above the light-receiving units 2, optical waveguides 4 are formed. Each of the optical waveguides 4 is formed by forming a recess portion in an insulation film, and by embedding in the recess portion material having a higher refractive index than silicon oxide. The optical waveguides 4 have the function of reflecting, and thus guiding light incident thereto to a corresponding one of the light-receiving units 2, without allowing the light to escape to the outside. Here, note that the light incident to a given one of the optical waveguides 4 is that collected by a corresponding one of microlenses 10.

Above the optical waveguides 4, the first color filters 9a and the second color filters 9b are disposed. Further, the barrier wall 8 is disposed between a pair of one of the first color filters 9a and one of the second color filters 9b that are adjacent to each other in FIG. 2. The barrier wall 8 partitions the adjacent color filters 9a and 9b from one another, and prevents light collected by one of the microlenses 10 corresponding to one pixel of the solid-state imaging device pertaining to the embodiment from entering (leaking into) an adjacent pixel.

In the solid-state imaging device pertaining to the embodiment, base layers each having one of the light-receiving units 2 formed therein are arranged at equal intervals. In such a structure, color mixture between adjacent pixels may occur when a width W₁ of the first color filter 9a is excessively greater than a width W₂ of the second color filter 9b. In view of this, it is exemplary to set the width W₁ and the width W₂ as follows. For example, when each pixel has a width of 1.4 μm, it is exemplary to set the width W₁ so as to be greater than the width W₂ by around 16%. For example, it is exemplary that the width W₁ be set to approximately 1.32 μm and the width W₂ be set to approximately 1.14 μm.

Note that as illustrated in FIG. 2, the solid-state imaging device pertaining to the embodiment includes a layered wiring layer 3 disposed above the semiconductor substrate 1 at an area corresponding to a gap between two adjacent light-receiving units 2. Further, note that the area illustrated in the right hand side of FIG. 2 in the X axis direction area has a structure differing from the area illustrated in the left hand side of FIG. 2 in the X axis direction, where the light-receiving units 2 are formed. Specifically, at an area in the right hand side of FIG. 2 corresponding to the area above the semiconductor substrate 1 in the left hand side of FIG. 2 where the color filters 9a and 9b are layered, an interlayer insulation film 5, a pad wiring layer 6, and a protection film 7 are layered in the stated order.

3. Intersection Portion of Barrier Wall 8

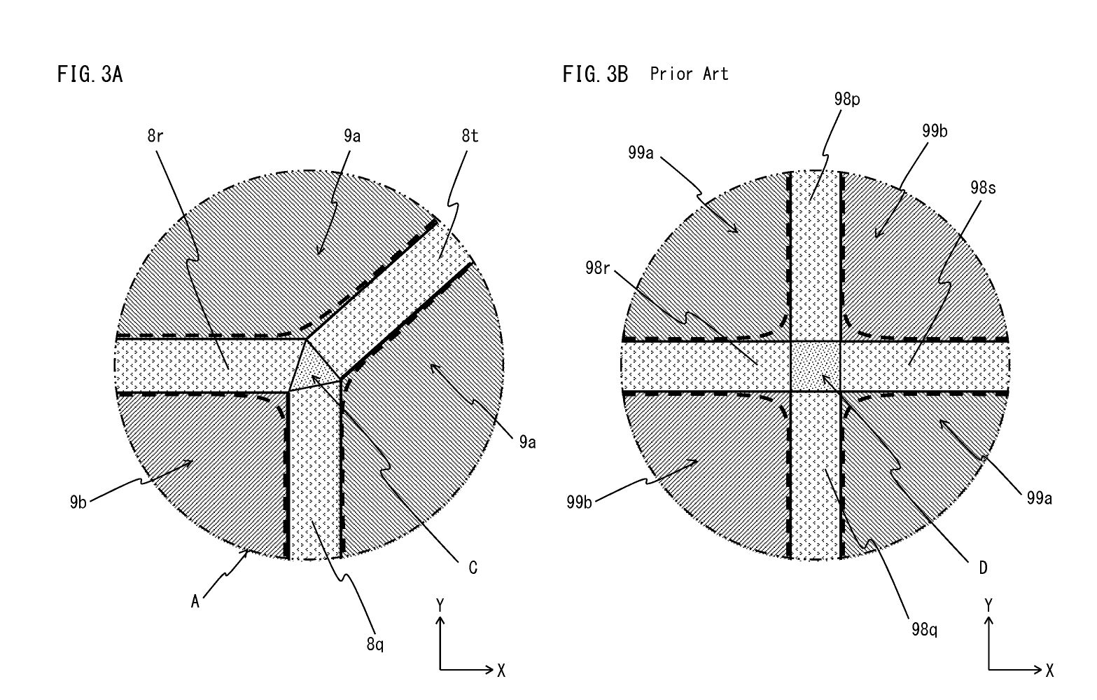

In the following, description is provided on an intersection portion of the barrier wall 8, with reference to FIGS. 3A and 3B. Each of FIGS. 3A and 3B is a plan view of part of a pixel region. FIG. 3A illustrates a structure of an intersection portion of the barrier wall 8 in the solid-state imaging device pertaining to the embodiment (FIG. 3A is an enlargement of part A in FIG. 1A). FIG. 3B illustrates a structure of the intersection portion of the barrier wall 98 in the solid-state imaging device pertaining to the conventional technology (FIG. 3B is an enlargement of part B in FIG. 1B). Note that the broken lines in FIGS. 3A and 3B indicate actual shapes of patterned resist films.

As illustrated in FIG. 3A, according to the structure of the barrier wall 8 pertaining to the embodiment, an intersection portion (indicated by the arrow C in FIG. 3A) of the barrier wall 8 has a three-way junction structure, where three barrier wall portions 8q, 8r, and 8t meet. On the other hand, according to the structure of the barrier wall 98 pertaining to the conventional technology, an intersection portion (indicated by the arrow D in FIG. 3B) of the barrier wall 98 has a crossroad structure, where four barrier wall portions 98p, 98q, 98r, and 98s meet. Here it should be noted that, when comparing the barrier wall 8 pertaining to the embodiment and the barrier wall 98 pertaining to the conventional technology, the intersection portion in the barrier wall 8 has a smaller area than the intersection portion in the barrier wall 98. As such, the solid-state imaging device pertaining to the embodiment, which includes the barrier wall 8 that is characterized as described above, suppresses color mixture.

Note that in the present disclosure, an area of an intersection portion is defined as an area of a portion of the barrier wall that is formed by connecting corner portions of color filters that abut each other at the intersection portion, as indicated by the arrows C and D in FIGS. 3A and 3B, respectively.

Here, note that in order to achieve the above-described effect of reducing the area of the intersection portion of the barrier wall 8, it is exemplary that a width of the shift portion of the bank 8, which is illustrated in FIG. 3A and extends diagonally, be set to no greater than √2 times the width of portions of the barrier wall 8 extending in the row direction and portions of the barrier wall 8 extending in the column direction. When, for example, setting the width of the shift portion of the barrier wall 8 equal to the width of the portions of the bank 8 extending in the vertical direction and the horizontal direction, the area of the intersection portion (indicated by the arrow C in FIG. 3A) is reduced by approximately 22% compared to in the conventional structure. Thus, color mixture is suppressed.

Further, as illustrated by using broken lines in FIGS. 3A and 3B, when actually patterning a resist film to form a barrier wall, portions of the patterned resist film corresponding to vertices of the color filters 9a and 9b have rounded shapes. As such, the actual area of the intersection portion (indicated by the arrows C and D in FIGS. 3A and 3B) is greater than the theoretical area of the intersection portion having an ideal shape (indicated by using solid lines in FIGS. 3A and 3B). Here, note that when patterning the resist film to form a corner potion having an acute angle, the portion of the patterned resist film corresponding to the corner portion is rounded to a relatively great extent, while when patterning the resist film to form a corner portion having an obtuse angle, the portion of the patterned resist film corresponding to the corner portion is rounded to a relatively small extent. In the present embodiment, a corner portion of the barrier wall 8 at which the first color filter 9a is to be formed has an angle greater than 90 degrees, as illustrated in FIG. 3A. Further, the intersection portion of the barrier wall 8, which has the three-way junction structure as described above (the portion indicated by the arrow C in FIG. 3A), is formed by one second color filter 9b, whose corner portion has an angle of 90 degrees, and two first color filters 9a, whose corner portions have an angle greater than 90 degrees.

Due to this, compared to the conventional structure where, at the intersection portion of the barrier wall 98, a crossroad structure is formed by two first color filters 99a, whose corner portions have an angle of 90 degrees, and one second color filter 99b, whose corner portion has an angle greater than 90 degrees as illustrated in FIG. 3B, the rounding of the corner portion of the patterned resist film is suppressed. Due to this, the difference between the actual area of the intersection portion and the theoretical area of the intersection portion having an ideal shape (indicated by using solid lines in FIGS. 3A and 3B) is reduced. As such, color mixture is suppressed.

4. Manufacturing Method

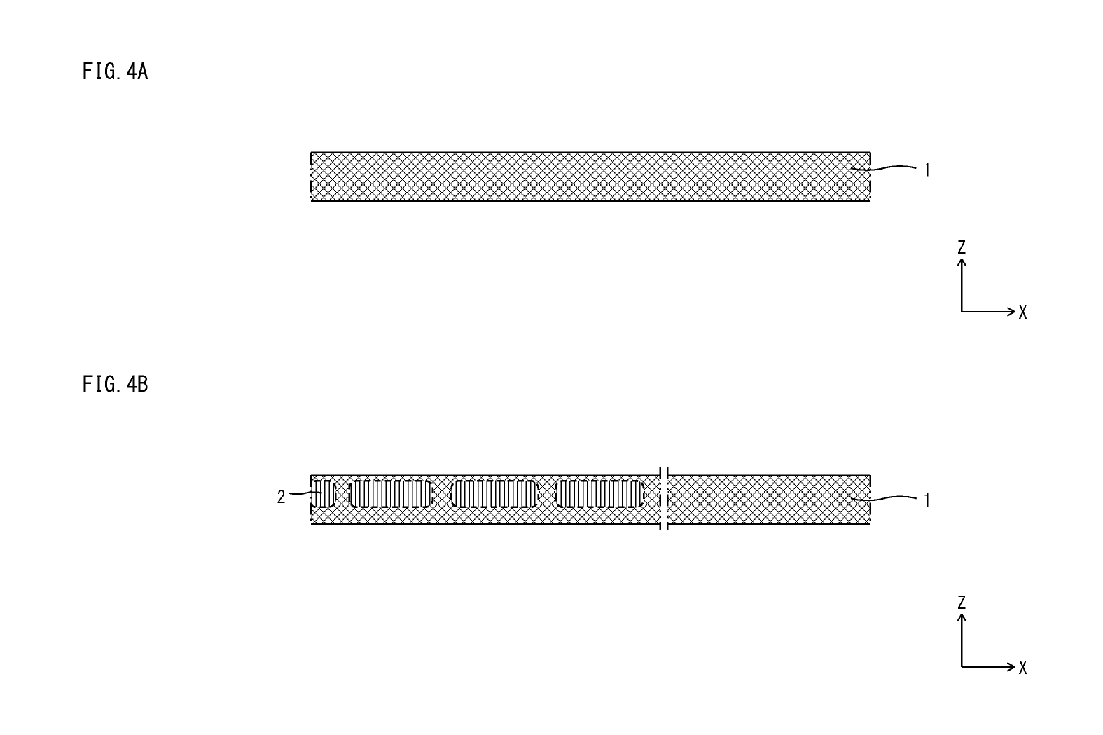

In the following, description is provided on a method for manufacturing the solid-state imaging device pertaining to the embodiment, with reference to FIGS. 4A and 4B, FIGS. 5A and 5B, FIGS. 6A and 6B, FIGS. 7A and 7B, and FIGS. 8A and 8B. FIGS. 4A and 4B, FIGS. 5A and 5B, FIGS. 6A and 6B, FIGS. 7A and 7B, and FIGS. 8A and 8B are schematic cross-sectional views each illustrating part of the manufacturing process of the solid-state imaging device pertaining to the embodiment.

First, as illustrated in FIG. 4A, the semiconductor substrate 1, which is an n-type semiconductor, is prepared. Then, as illustrated in FIG. 4B, by performing ion implantation with respect to the semiconductor substrate 1, the light-receiving units 2 are formed. Note that in FIG. 4B, the area in the left hand side of the line with alternate long and two short dashes is a pixel region of the solid-state imaging device, whereas the area in the right hand side of the line with alternate long and two short dashes is a peripheral circuit area of the solid-state imaging device.

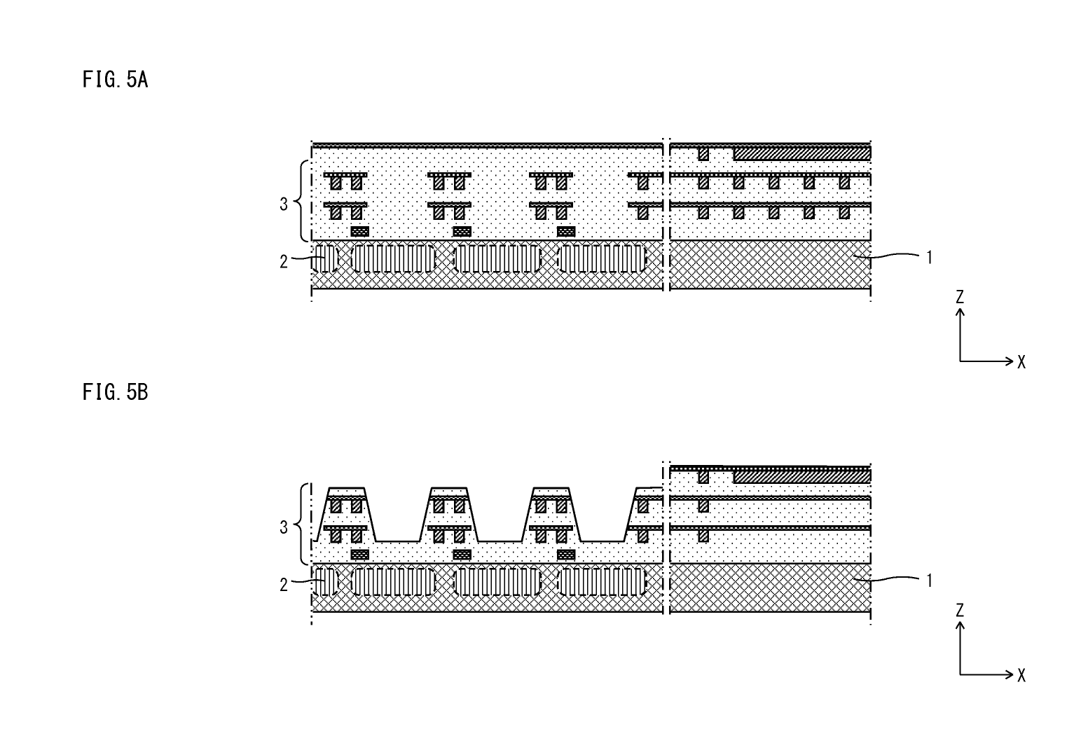

Subsequently, the layered wiring layer 3 is formed by alternately layering insulation films made of silicon oxide, etc., and metal films of copper, for example, as illustrated in FIG. 5A.

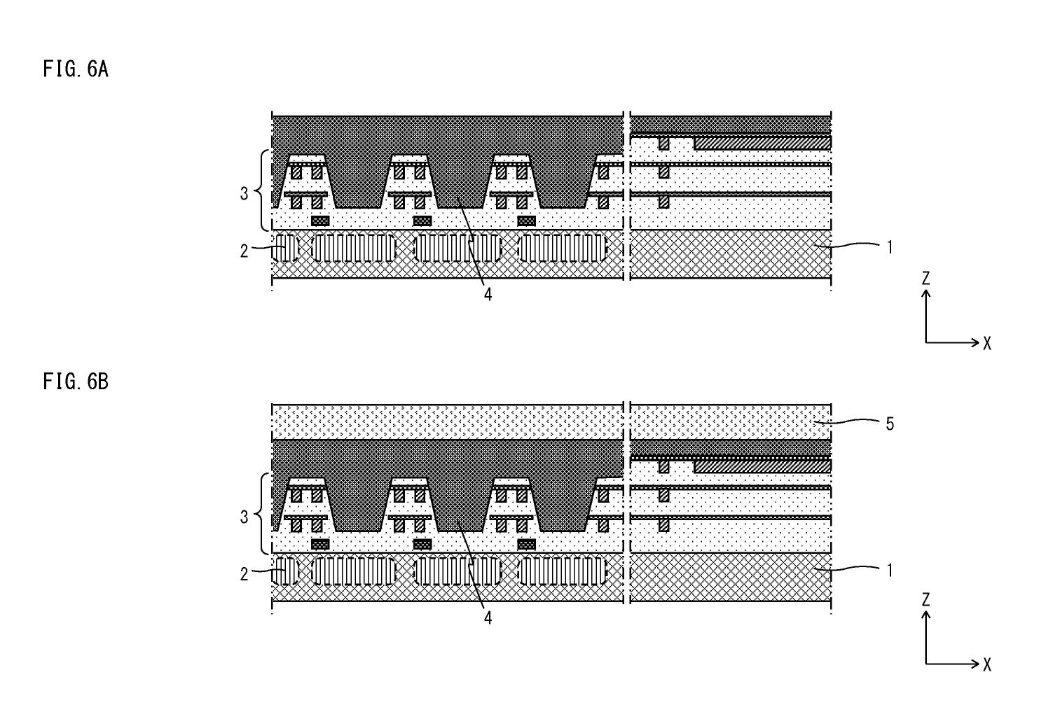

Then, as illustrated in FIG. 5B, apertures are formed in the layered wiring layer 3 by etching interlayer film portions (portions of the insulation films) above the light-receiving units 2. Further, the optical waveguides 4 are formed by embedding material having a relatively high refractive index in the apertures so formed, as illustrated in FIG. 6A. Here, it is exemplary that the material embedded in the apertures for forming the optical waveguides 4 be material having a higher refractive index than silicon oxide (having a refractive index n of approximately 1.5). For example, the material for forming the optical waveguides 4 may be silicon nitride (having a refractive index n of approximately 2.0)

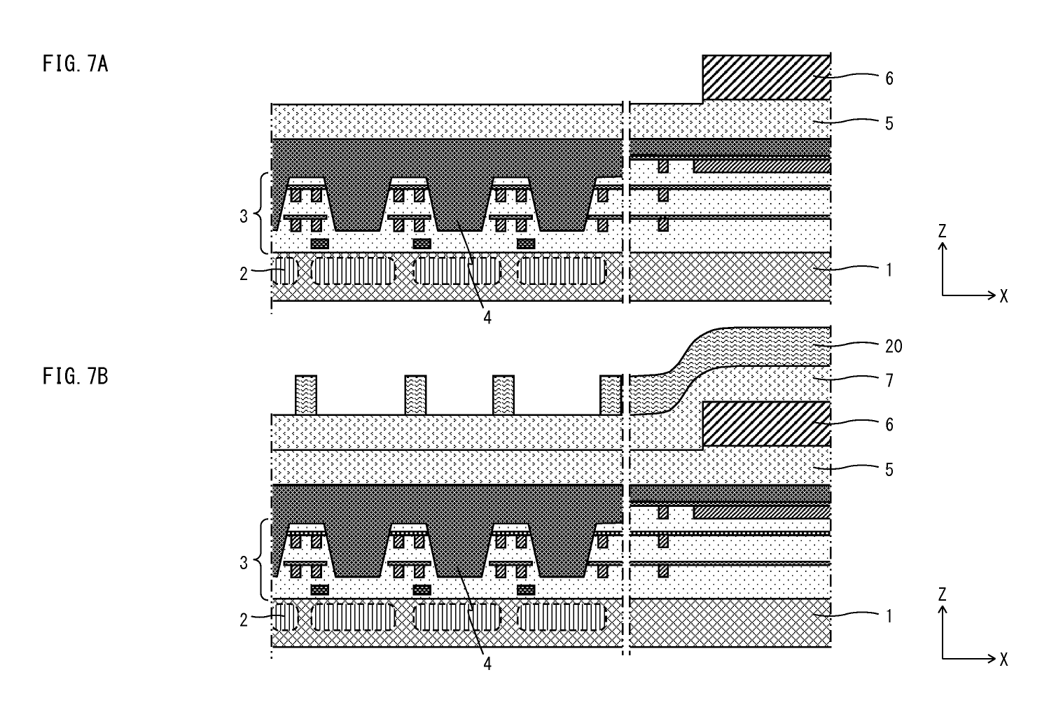

Further, after planarizing upper portions of the optical waveguides 4 by etch-back planarization, the interlayer insulating layer 5 made of transparent inorganic material having a refractive index n of approximately 1.5, such as silicon oxide, is deposited by CVD or the like, as illustrated in FIG. 6B. Subsequently, as illustrated in FIG. 7A, a bonding pad 6 is formed on the interlayer insulation film 5 by depositing a metal layer made of aluminum or the like on the interlayer insulation film 5 and by etching the metal layer so formed.

Then, as illustrated in FIG. 7B, deposition of the protective film 7, which is made of transparent inorganic material having a refractive index n of approximately 1.5, such as silicon oxide, is performed by CVD or the like, and then a photoresist film 20 is formed. Subsequently, patterning is performed by using the photoresist film 20 as illustrated in FIG. 1A, such that the barrier wall 8 to be formed has the shift portions extending in diagonal directions and the three-way junction structure at each intersection portion (indicated by the arrow A in FIG. 1A).

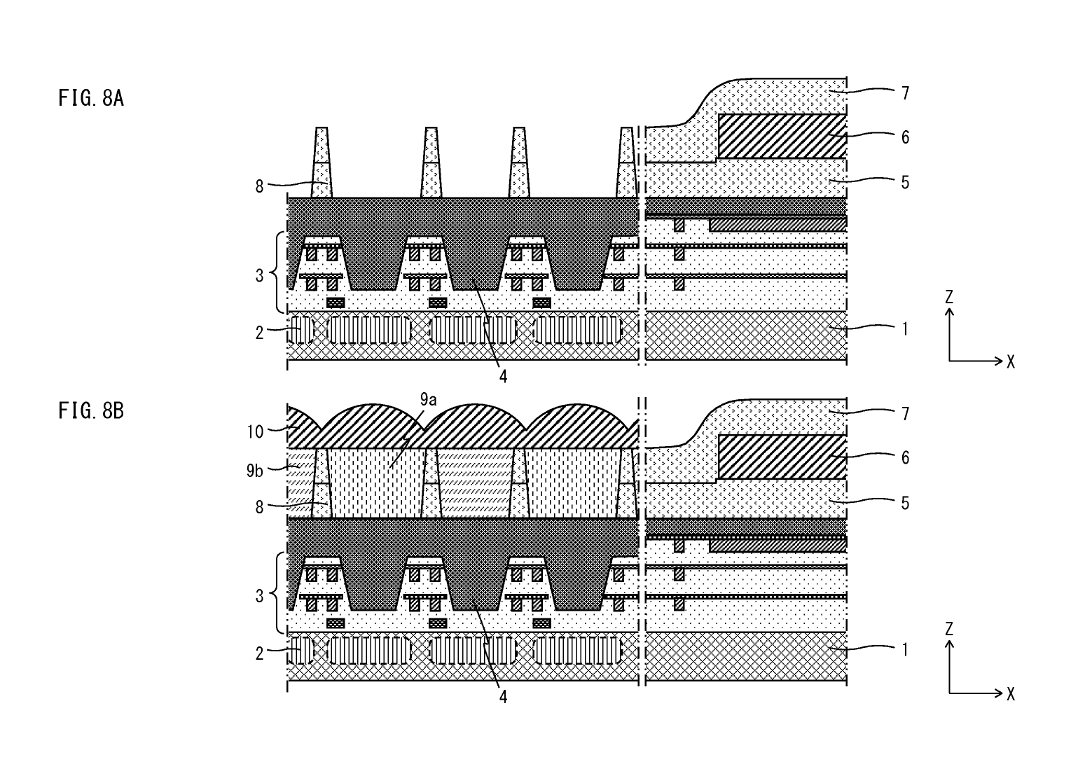

Then, as illustrated in FIG. 8A, the interlayer insulation film 5 and the protective film 5 are etched to the extent that the material embedded in the optical waveguides 4 is exposed from between portions of the interlayer insulation film 5 and the protective film 5 remaining after the etching. Thus, the barrier wall 8 is formed. Here, note that the height of the barrier wall 8, which corresponds to a total of the film thickness of portions of the interlayer insulation film 5 and the film thickness of the portions of the protective film 7 remaining after the etching, is approximately 500 nm to 900 nm, for example. Further, it is exemplary that the barrier wall 8 have a width of approximately 100 nm to 300 nm, for example.

Then, as illustrated in FIG. 8A, in each area between portions of the barrier wall 8, the first color filter 9a, which corresponds to the color green (G) or the second color filter 9b, which corresponds to the color red (R) or blue (B), is formed, for example. Here, the first color filters 9a and the second color filters 9b are formed to have a film thickness of approximately 500 nm to 900 nm. Further, above the first color filters 9a and the second color filters 9b so formed, the microlenses 10 made of organic material are formed by dry etching. Here, the patterning and the dry etching for forming the microlenses 10 are performed such that the mircrolenses 10 corresponding to the first color filters 9a and the microlenses 10 corresponding to the second color filters 9b have different sizes corresponding to the size of the first color filters 9a and the size of the second color filters 9b, respectively. By forming the microlenses 10 to have different sizes in accordance with the sizes of the first color filters 9a and the second color filters 9b, the efficiency with which the microlenses 10 collect light is improved.

Through the procedures described above, the first color filters 9a having an octagonal shape and the second color filters 9b having a rectangular shape are formed alternately in each of the row direction and the column direction, and thus in a checkerboard pattern in the solid-state imaging device pertaining to the embodiment as illustrated in FIG. 1A.

5. Effects Achieved

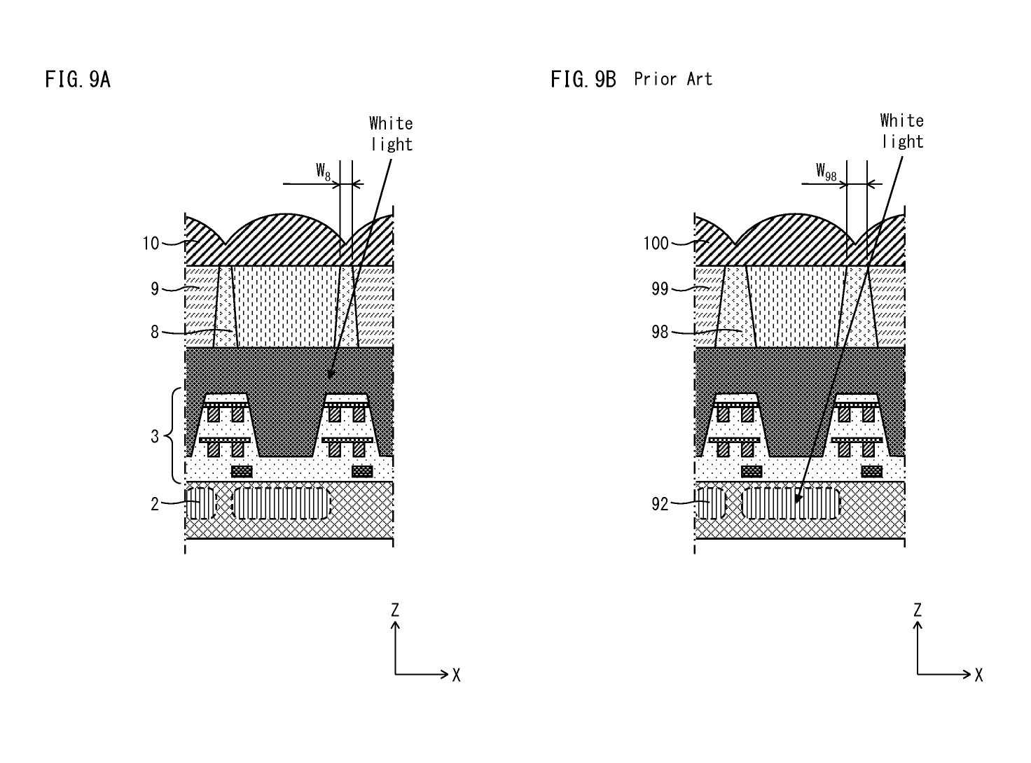

In the following, description is provided on the effects achieved by the solid-state imaging device pertaining to the embodiment, which has the structure as described above, with reference to FIGS. 9A and 9B. FIG. 9A is a schematic diagram illustrating why light passing through an upper portion of the barrier wall 8 does not reach the image-receiving unit 2 formed in the semiconductor substrate 1 when adopting the structure pertaining to the present embodiment. Note that a width W₈ of the barrier wall 8 is relatively small in the structure pertaining to the present embodiment. On the other hand, FIG. 9B illustrates a case where the structure pertaining to the conventional technology is adopted. Note that a width W₉₈ of the barrier wall 98 is relatively great in the structure pertaining to the conventional technology.

First of all, due to being made of material having high transmissivity with respect to light, such as silicon oxide, the barrier wall 8 and the barrier wall 98 both transmit light.

In the conventional structure illustrated in FIG. 9B, the intersection portion of the barrier wall 98 has the crossroad structure as illustrated in FIG. 3B. Due to this, the width W₉₈ of the barrier wall 98 is relatively great, and thus, the intersection portion has a relatively great area. Due to this, light passing through an upper portion of the barrier wall 98 reaches the light-receiving units 92 formed in the semiconductor substrate in the conventional structure. Here, it should be noted that since the incident light has not transmitted through the color filter 99, white light directly enters the light-receiving units 92. Thus, components of colors other than the desired color increases in the light received by the light-receiving units 92, and thus, a solid-state imaging device including a barrier wall having such a structure has inferior characteristics in terms of color mixture.

In contrast, in the structure pertaining to the present embodiment illustrated in FIG. 9A, the intersection portion of the barrier wall 8 has the three-way junction structure as illustrated in FIG. 3A. Accordingly, the width W₈ of the barrier wall 8 is relatively small, and thus, the intersection portion has a relatively small area. Due to this, light passing through an upper portion of the barrier wall 8 does not reach the light-receiving units 2 formed in the semiconductor substrate 1 in the structure pertaining to the embodiment. Thus, color mixture is suppressed.

As described above, the present embodiment is based on an arrangement where the first color filters 9a are color filters mainly transmitting light within a wavelength range corresponding to green light, and the second color filters 9b include color filters mainly transmitting light within a wavelength range corresponding to red light and color filters mainly transmitting light within a wavelength range corresponding to blue light. This is since this arrangement, improves the sensitivity of the solid-state imaging device with respect to the color green. However, the arrangement of the color filters in the solid-state imaging device is not limited to the arrangement described above.

### [Other Matters]

In the above-described embodiment, the solid-state imaging device is implemented as a metal oxide semiconductor (MOS) type solid-state imaging device. However, the present invention is not limited to this, and similar effects can be achieved when implementing the solid-state imaging device as a charge coupled device (CCD) type solid-state imaging device.

### INDUSTRIAL APPLICABILITY

The present invention is useful in realizing a solid-state imaging device that prevents color mixture while having high imaging performance.

### REFERENCE SIGNS LIST

1 semiconductor substrate
2 light-receiving unit
3 layered wiring layer
4 optical waveguide
5 interlayer insulation film
6 pad wiring layer
7 protection film
8 barrier wall
9 color filter
9a first color filter
9b second color filter
10 microlens
20 photoresist film

1. A solid-state imaging device comprising:
a semiconductor substrate;
a plurality of photoelectric conversion units disposed in the semiconductor substrate so as to form a matrix along a main surface of the semiconductor substrate;
a wiring layer disposed above the semiconductor substrate;
a plurality of color filters disposed above the wiring layer, the color filters each corresponding to a different one of the photoelectric conversion units, and thus forming a matrix; and
a barrier wall disposed above the wiring layer and between adjacent ones of the color filters, wherein
the color filters are composed of a plurality of first color filters and a plurality of second color filters, and
in plan view from a direction perpendicular to the main surface of the semiconductor substrate,
in the matrix formed by the color filters, the first color filters and the second color filters are arranged alternately in each of a row direction and a column direction, and thus form a checkerboard pattern,
the first color filters are greater than the second color filters in terms of area, and
each one of the first color filters, at a corner portion thereof, (i) has an oblique side that extends diagonally with respect to the row direction and the column direction, and (ii) is adjacent to another one of the first color filters that is located diagonally therefrom, the each one of the first color filters being partitioned from the another one of the first color filters by a shift portion of the barrier wall that extends in parallel with the oblique side.

2. The solid-state imaging device of claim 1, wherein
in plan view from the direction perpendicular to the main surface of the semiconductor substrate, at the corner portion of the each one of the first color filters, each of a side that extends in the row direction and a side that extends in the column direction meets the oblique side at an angle greater than 90 degrees.

3. The solid-state imaging device of claim 1, wherein
the first color filters are color filters that mainly transmit light within a green wavelength range, and
the second color filters are composed of color filters that mainly transmit light within a red wavelength range and color filters that mainly transmit light within a blue wavelength range.

4. The solid-state imaging device of claim 1 further comprising:
a plurality of microlenses disposed above the color filters, the microlenses each corresponding to a different one of the color filters, wherein
the microlenses are composed of a plurality of first microlenses each corresponding to a different one of the first color filters and a plurality of second microlenses each corresponding to a different one of the second color filters, and
in plan view from the direction perpendicular to the main surface of the semiconductor substrate, the first microlenses are greater than the second microlenses in terms of size.

5. The solid-state imaging device of claim 1, wherein
in plan view from the direction perpendicular to the main surface of the semiconductor substrate,
the barrier wall, in the row direction, has a continuous crank shape such that a position of the barrier wall in the column direction alternates between a first position and a second position with the shift portion connecting a first portion and a second portion of the barrier wall respectively corresponding to the first position and the second position, the first portion and the second portion each extending in the row direction and each disposed between two color filters, among the color filters, that are adjacent in the column direction, the two color filters between which the first portion is disposed and the two color filters between which the second portion is disposed being adjacent to each other in the row direction.

6. The solid-state imaging device of claim 1, wherein
in plan view from the direction perpendicular to the main surface of the semiconductor substrate,
the barrier wall, in the column direction, has a continuous crank shape such that a position of the barrier wall in the row direction alternates between a first position and a second position with the shift portion connecting a first portion and a second portion of the barrier wall respectively corresponding to the first position and the second position, the first portion and the second portion each extending in the column direction and each disposed between two color filters, among the color filters, that are adjacent in the row direction, the two color filters between which the first portion is disposed and the two color filters between which the second portion is disposed being adjacent to each other in the column direction.

7. The solid-state imaging device of claim 1, wherein
in plan view from the direction perpendicular to the main surface of the semiconductor substrate, the first color filters have an octagonal shape, and the second color filters have a rectangular shape.
